(19) United States
(12) Patent Application Publication
(10) Pub. No.: US 2012/0262034 A1
(43) Pub. Date: Oct. 18, 2012

(54) SPINDLE MOTOR

(75) Inventors: Yun Yeong Park, Gyunggi-do (KR); Young Sun Yoo, Gyunggi-do (KR); Ho Jun Yoo, Gyunggi-do (KR)

(73) Assignee: SAMSUNG ELECTRO-MECHANICS CO., LTD., Gyunggi-do (KR)

(21) Appl. No.: 13/184,734

(22) Filed: Jul. 18, 2011

(30) Foreign Application Priority Data
Apr. 14, 2011 (KR) 1020110034794

(51) Int. Cl. H02K 5/22

(52) U.S. Cl. 310/68 R

(57) ABSTRACT

Disclosed herein is spindle motor including a rotating part, including: a rotating shaft and a magnet; a fixing part including a bearing supporting the rotating shaft, an armature opposite to the magnet, a printed circuit board applying power to the armature, and a base plate coupled with the rotating part, wherein the rotating part rotates by electromagnetic force of the magnet and the armature, and an end of the base plate contacting the printed circuit board is provided with a downward inclined part having a round shape so as to be coupled with the printed circuit board.

### CROSS REFERENCE TO RELATED APPLICATION

This application claims the benefit of Korean Patent Application No. 10-2011-0034794, filed on Apr. 14, 2011, entitled “Spindle Motor” which is hereby incorporated by reference in its entirety into this application.

### BACKGROUND OF THE INVENTION

1. Technical Field

The present invention relates to a spindle motor.

2. Description of the Related Art

Generally, a spindle motor is a device that is mounted in a hard disk drive, an optical disk drive, and other recording media requiring high-speed rotation to drive a turntable so as to rotate a disk mounted in the turntable.

The spindle motor according to the prior art include a chucking assembly that includes a rotating shaft, a rotor case, a bearing holder rotatably supporting the rotating shaft, an armature configured to include a coil and a core, a base plate coupled with a printed circuit board, and a turntable mounted with a disk.

In detail, a magnet is provided in the rotor case. The magnet generates electromagnetic force for rotating the rotor case by electromagnetic interaction with the armature.

In addition, the bearing holder has the bearing rotatably supporting the rotating shaft coupled with an inner peripheral surface thereof, the armature coupled with an outer peripheral surface thereof, and the base plate coupled thereunder.

Further, a top surface or a bottom surface of the printed circuit board may be optionally provided with circuit patterns or the top and bottom surfaces thereof may be provided with the circuit patterns.

In addition, the printed circuit board having the circuit patterns provided on the top surface or/and bottom surface thereof is fixedly coupled with the top portion of the base plate.

The base plate is generally made of a metal material and is manufactured in a mold manufacturing method using a press. In this case, burr may be formed at an end of the base plate manufactured by a punching of the press.

Therefore, the printed circuit board coupled with the top portion of the base plate and the circuit patterns formed on the printed circuit board may be damaged due to the burr formed on the base plate.

### SUMMARY OF THE INVENTION

The present invention has been made in an effort to provide a spindle motor having a round shape formed at an end of a base plate contacting a printed circuit board.

According to a preferred embodiment of the present invention, there is provided a spindle motor, including: a rotating part including a rotating shaft and a magnet; a fixing part including a bearing supporting the rotating shaft, an armature being opposite to the magnet, a printed circuit board applying power to the armature, and a base plate coupled with the rotating part, wherein the rotating part rotates by electromagnetic force of the magnet and the armature, and an end of the base plate contacting the printed circuit board is provided with a downward inclined part having a round shape.

The end of the base plate may contact the printed circuit board and may be formed to have a round shape by a reverse punching manufacturing process using a punching of a press.

The printed circuit board may be a flexible printed circuit (FPC) or a flexible flat cable (FFC).

The rotating part may include: a rotor case having the rotating shaft inserted into a center thereof and the magnet attached to the inside thereof so as to integrally rotate with the rotating shaft; and a bearing holder rotatably supporting the bearing.

The rotor case may include: a disk part extending to one side while being fixedly mounted to the rotating shaft; and an annular edge part vertically extending from an end of the disk part downwardly, the magnet being attached inside the annular edge part.

The top portion of the bearing holder or the armature may be optionally mounted with a suction magnet having a ring shape so as to suppress the floating of the rotor case.

The top surface or the bottom surface of the printed circuit board may be provided with the circuit patterns.

### BRIEF DESCRIPTION OF THE DRAWINGS

FIG. 1 is a cross-sectional view of a spindle motor according to a preferred embodiment of the present invention.

FIG. 2 is a plan view of a coupling relationship between a printed circuit board and a base plate of the spindle motor shown in FIG. 1.

FIG. 3 is a cross-sectional view of a coupling relationship between the printed circuit board and the base plate of the spindle motor shown in FIG. 2.

### DESCRIPTION OF THE PREFERRED EMBODIMENTS

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted. In the description, the terms “first”, “second” and so on are used to distinguish one element from another element, and the elements are not defined by the above terms. The terms are only used to differentiate one component from other components. Further, when it is determined that the detailed description of the known art related to the present invention may obscure the gist of the present invention, a detailed description thereof will be omitted.

Hereinafter, preferred embodiments of the present invention will be described in detail with reference to the accompanying drawings.

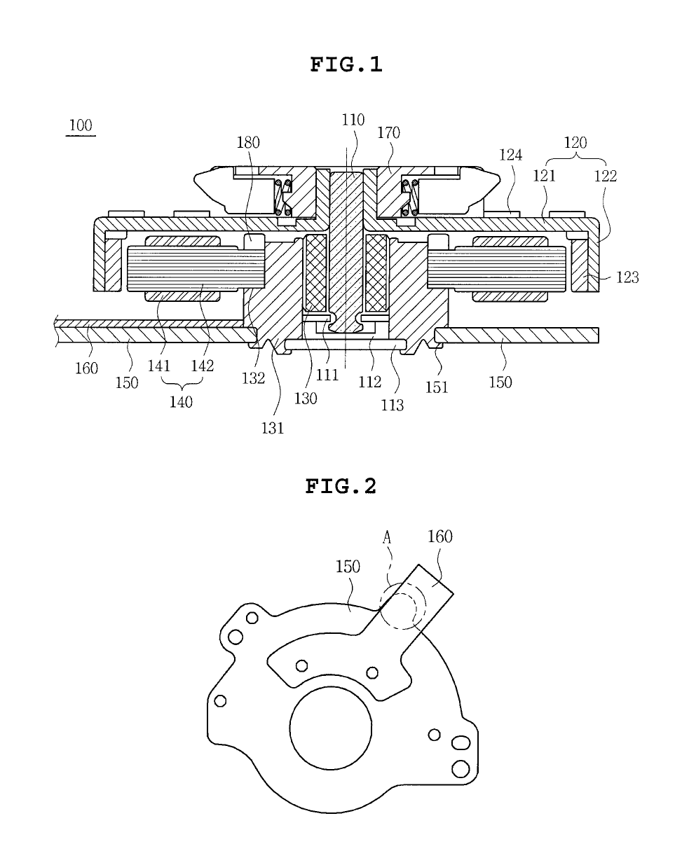

FIG. 1 is a cross-sectional view of a spindle motor according to a preferred embodiment of the present invention. As shown, a spindle motor 100 may be configured to include a rotating part including a rotating shaft 110 and a magnet 123 and a fixing part including a bearing 130, an armature 140, a printed circuit board 160, and a base plate 150.

The rotating shaft 110 is inserted into a hollow hole having a cylindrical shape formed at a center of a rotor case 120 to axially support the rotor case 120, thereby integrally rotating with the rotor case 120.

In addition, a bottom end portion of the rotating shaft 110 is coupled with a stopper 111 so as to prevent a separation of the rotating shaft 110.

Further, the rotating shaft 110 is axially supported by a thrust washer 112, wherein the thrust washer 112 is fixedly mounted to a thrust washer cap 113.

The rotor case 120, which is an upper case of the spindle motor 100, integrally rotates with the rotating shaft 110 according to the rotation of the rotating shaft 110 by inserting the rotating shaft 110 into a cylindrical hollow hole formed at a center thereof.

In detail, the rotor case 120 includes a disk part 121 that extends to one side while being fixedly mounted to the rotating shaft 110 and an annular edge part 122 that vertically extends from an end of the disk part 121 downwardly.

The inner side of the annular edge part 122 is attached with the magnet 123 that generates electromagnetic force by electromagnetic interaction with the armature 140 to rotate the rotor case 120.

Further, the top portion of the rotor case 120 may be provided with the chucking assembly 170 for chucking the disk and the top portion of the disk part 121 may be coupled with a slip prevention member 124 for preventing the slip of the disk.

The bearing 130 rotatably supports the rotating shaft 110 and the outer peripheral surface thereof is supported by the bearing holder 131 including the hollow hole having a cylindrical shape.

Further, a lubricant component may be inserted between the bearing 130 and the rotating shaft 110.

Further, the bearing holder 131 is inserted into a coupling groove 151 formed on the base plate 150 to be fixedly coupled with the base plate 150.

In addition, the outer peripheral surface of the bearing holder 131 is provided with a step part to form a coupling surface 132 with which the armature 140 is fixedly coupled.

The armature 140 is to form electric field by being applied with external power and is configured to include a core 141 and a coil 142 wound around the core 141.

In more detail, the armature 140 is fixedly seated in the coupling surface 132 formed on the bearing holder 131 so as to be opposite to the magnet 123 coupled with the annular edge part 122 of the rotor case 120.

Further, the coil 142 is wound around the outer peripheral surface of the core 141 several times so as to form electric field using power applied from the outside.

As a result, when the armature 140 is applied with power from the outside, electromagnetic force rotating the rotor case 120 is generated by the electromagnetic interaction with the magnet 123 coupled with the annular edge part 122 of the rotor case 120.

In addition, as shown, the top portion of the armature 140 is mounted with a suction magnet 180 having a ring shape so as to prevent the rotor case 120 from floating due to magnetic attraction with the rotor case 120.

According to the preferred embodiment of the present invention, the suction magnet 180 is mounted on the top portion of the armature 140 but may be optionally mounted on the top portion of the bearing holder 131.

Further, the suction magnet 180 may have larger magnetism than the magnet 123.

The base plate 150 is to completely fixedly support the spindle motor 100 and is fixedly mounted to a device such as a hard disk drive in which the spindle motor 100 is mounted.

Further, the base plate 150 may be made of a metal material having magnetism that may generate the magnetic attraction with the magnet 123.

In more detail, since the base plate 150 is manufactured by a mold manufacturing method using a press, the burr may occur at the end of the base plate 150, that is, area A, as shown.

Therefore, in order to remove the burr that may occur when the base plate 150 according to the preferred embodiment of the present invention is manufactured, the base plate 150 may be manufactured so that the end of the base plate 150 contacting the printed circuit board 160 may be provided with a downward inclined part 151 having a round shape by performing a reverse punching process so as to face the punching of the press downwardly from above the base plate 150 to which the printed circuit board 160 is fixedly coupled.

The top surface or/and the bottom surface of the printed circuit board 160 are optionally provided with the circuit patterns (not shown) for supplying external power to the armature 140 and the printed circuit board 160 is fixedly coupled with the top portion of the base plate 150.

Further, the printed circuit board may be formed of a flexible printed circuit (FPC) or a flexible flat cable (FFC) having a flexible material so as to electrically connect to peripheral components.

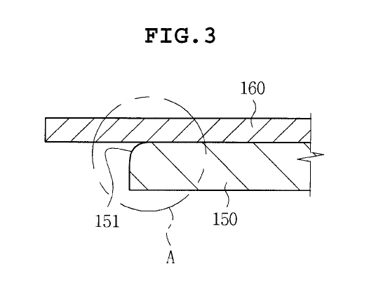

FIG. 2 is a plan view of a coupling relationship between a printed circuit board and a base plate of the spindle motor shown in FIG. 1 and FIG. 3 is a cross-sectional view of a coupling relationship between the printed circuit board and the base plate of the spindle motor shown in FIG. 2.

As shown, the printed circuit board 160 is fixedly coupled with the base plate 150.

In more detail, a portion of the printed circuit board 160 having the circuit patterns optionally formed on the top surface or/and the bottom surface thereof is fixedly coupled with the top portion of the base plate 150 and the other remaining portion thereof is formed so as to be protruded to the outside of the base plate 150.

Therefore, as shown, the end of the base plate 150 contacting the printed circuit board 160 is provided with the downward inclined part 151 having the round shape, such that the damage of the printed circuit board 160 and the circuit patterns that may be formed on the bottom surface of the printed circuit board 160 may be prevented.

As set forth above, the preferred embodiment of the present invention forms, as the round shape, the end of the base plate contacting the printed circuit board having the circuit patterns optionally formed on the top surface or/and the bottom surface thereof, thereby preventing the printed circuit board and the circuit patterns formed on the printed circuit board from being damaged due to the burr.

Although the embodiment of the present invention has been disclosed for illustrative purposes, it will be appreciated that a spindle motor according to the invention is not limited thereby, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A spindle motor, comprising:
a rotating part including a rotating shaft and a magnet;
a fixing part including a bearing supporting the rotating shaft, an armature being opposite to the magnet, a printed circuit board applying power to the armature, and a base plate coupled with the rotating part,
wherein the rotating part rotates by electromagnetic force of the magnet and the armature, and
an end of the base plate contacting the printed circuit board is provided with a downward inclined part having a round shape.

2. The spindle motor as set forth in claim 1, wherein the end of the base plate contacts the printed circuit board and is formed to have a round shape by a reverse punching manufacturing process using a punching of a press.

3. The spindle motor as set forth in claim 1, wherein the printed circuit board is a flexible printed circuit (FPC) or a flexible flat cable (FFC).

4. The spindle motor as set forth in claim 1, wherein the rotating part includes:
a rotor case having the rotating shaft inserted into a center thereof and the magnet attached to the inside thereof so as to integrally rotate with the rotating shaft; and
a bearing holder rotatably supporting the bearing.

5. The spindle motor as set forth in claim 4, wherein the rotor case includes:
a disk part extending to one side while being fixedly mounted to the rotating shaft; and
an annular edge part vertically extending from an end of the disk part downwardly,
the magnet being attached inside the annular edge part.

6. The spindle motor as set forth in claim 1, wherein the top portion of the bearing holder or the armature is optionally mounted with a suction magnet having a ring shape so as to suppress the floating of the rotor case.

7. The spindle motor as set forth in claim 1, wherein the top surface or the bottom surface of the printed circuit board is optionally provided with the circuit patterns.
